(19) United States
(12) Patent Application Publication
(10) Pub. No.: US 2016/0219796 A1
(43) Pub. Date: Aug. 4, 2016

(54) GREENHOUSE ROOFING HAVING TEMPERATURE-DEPENDENT RADIATION TRANSPARENCY AND METHOD FOR CULTIVATING USEFUL PLANTS

(71) Applicant: TROPOTHERM, S.L., Retamar (Almeria) (ES)

(72) Inventor: Emilio RODRIGUEZ CABEO, Meine (DE)

(21) Appl. No.: 14/392,131

(22) PCT Filed: Jun. 26, 2014
(86) PCT No.: PCT/EP2014/001746

§ 371 Date: Dec. 23, 2015

(30) Foreign Application Priority Data
Jun. 27, 2013 (DE) 10 2013 010 702.4

(51) Int. Cl. A01G 9/14; A01G 1/00

(52) U.S. Cl. CPC A01G 9/1438; A01G 1/001; A01G 9/14

(57) ABSTRACT

In plant cultivation, it is common in many cases to grow certain crops under film covers, in greenhouses (100), or under other roofings (200). Depending on the climate zone and crop, this can be used for example to supply heat by retaining the sunlight or by means of additional heating. The invention relates to a plant cultivation roofing (10) made of film material or plate material having temperature-dependent radiation transparency, wherein a plastic layer in or on a plate or at least one film layer having temperature-dependent radiation transparency provides a gradual or a two-step or multi-step transparency reduction for rising temperatures in a temperature range from 20° C.

The invention relates to a plant cultivation roofing made of film material or plate material having temperature-dependent radiation transparency. The invention further relates to a master blend for producing a temperature-dependently radiation transparent film or plastic layer for use in the plant cultivation roofings; the film or layer is produced in particular by extrusion or rather co-extrusion, or extrusion coating of a substrate. The invention relates lastly to a method for cultivating or growing useful plants with the aid of plant cultivation roofings, e.g., in a greenhouse, under a roofing, or under a film cover.

In plant production it is a common practice to grow certain crops under film covers, in greenhouses, or under other roofings or canopies. Depending on the climate zone and the crop, this can be used, for example, to supply heat by retaining sunlight or by means of additional heating. In the event of large temperature differences between day and night, the covering or roofing of greenhouses can prevent excessive cooling overnight. Additionally, greenhouses and covers can retain moisture on the crop better or else enable, depending on the structure, better drying by means of the retained heat. With greenhouses and other roofings, it is also possible to provide additional shading of the crops against too intense solar radiation, for example with blinds or awnings. However, such mechanical shading involves considerable technical effort and therefore higher costs as well.

In southern regions it is a widespread practice to whitewash or lime greenhouses and other roofings during particularly hot periods with high solar radiation. In this process a lime solution is applied to the roofs, where it cuts down on the amount of solar radiation that can pass through the glass or film. Whitewashing mainly increases light reflection. Whitewashing is also associated with additional expense, specifically for the material itself, the transport thereof, and the labor for applying the lime and washing it off when more light transmission is required. With whitewashing, the shading is not self-adaptive and the conditions for plant growth are not ideal.

Plastic films, which have been improved over the years in terms of their elasticity, durability, and UV resistance, are being used to an increasingly greater extent for greenhouses and other roofings. Plastics can be enhanced in terms of many physical properties by means of additives as well as by alteration of the plastics themselves, which has promoted the development of self-shading and plant growth-influencing roofing films, among other things.

Instead of whitewashing, attempts have been made, for example, to tint the films. As a rule, however, the pigments cause the spectral composition of the transmitted light to change, which can not only affect plant development itself but also the susceptibility to plant diseases and the orientation of pollinating insects. In most cases this is undesirable. The tinted films also include thermochromic films, which provide a temperature-dependent color filter.

Plants require the spectral range of 400 to 720 nanometers for photosynthesis and healthy growth. This range is therefore designated as “photosynthetically active radiation (PAR)”. The covers used for the crops should allow these wavelengths to pass through with as little distortion as possible. Increasing the fraction of diffuse radiation in the PAR range is beneficial. In principle the transparency to diffuse light fractions should remain high, because this best corresponds to natural lighting conditions. High light diffusion ensures better light supply and photosynthesis of the lower plant portions, especially in crops that cast many shadows.

As a rule good thermicity, i.e., good heat-retaining capacity, is also expected of cover materials. This is typically achieved by adding mineral additives to the cover films. For good thermicity, a certain fraction of infrared, especially of near infrared in the range of 780 and 3000 nm, should pass through the cover film or the covering plastic material. This infrared is absorbed by the soil, partially stored and then gradually released as longer wavelength radiation. The covering material should be practically impermeable to the longer-wavelength, far infrared with wavelengths in the ca. 3 to 50 μm range so that the trapped heat can be retained under the covering.

For promoting plant growth in somewhat colder climate zones, DE 10 2004 051 354 A1 (Grafe), for example, proposes a plastic material for greenhouse films and other agricultural and horticultural roofings that is modified with nanoparticles of semi-conductor materials. Semi-crystalline thermoplastics, in particular ones such as polyethylene, polypropylene, EVA, and PET, are used as matrix plastics. High absorption rates in the near infrared range with high degrees of light transmission in the PAR range are achieved by the doping. In warm climate zones these roofing materials lead to overheating because the films and plastic materials are not self-shading and cannot regulate light irradiation. For further improving the growing conditions of greenhouse plants or plants protected with various kinds of covers and roofings, so-called thermotropic greenhouse films were developed. Thermotropic performance is understood to mean one in which physical properties and especially optical properties of the material change with the temperature. The desired effect of this is to have greater light permeability at lower temperatures and less light permeability or rather transparency at higher temperatures. This is often achieved through specific measures that induce opacity at higher temperatures. The opacity of the plastic material increases (in general suddenly) above a certain temperature, usually due to separation phenomena or rather alterations of the microstructure, phase change or phase transition phenomena, or refractive index divergence (e.g., DE 44 33 090 A1).

Accordingly, EP 1 218 467 B1 (BASF) describes thermotropic films and film composites with at least one thermotropic polymer layer made of a fused polymer mixture of at least two polymer components with different refractive indexes, wherein a molecular mixture of the two components has an opacity temperature below which a single-phase, transparent mixture is present and above which this mixture separates into its individual components, thus resulting in opacity and reduced transparency of the layer due to the increased refraction. The material can contain additional components such as surfactants, photoinitiators and standard ingredients such as emollients, dyes, pigments, stabilizers, processing agents, and rheological additives. The thermotropic film can then be cross-linked. Its properties are based on a microstructure. The alterations of the transparency are reversible. EP 1 218 467 B1 (BASF) mentions numerous monomers for the two components that can be used for the thermotropic polymer film or polymer layer. The layer material is thus a mixture or a polymer blend.

DE 44 33 090 A1 (Frauenhofer-Gesellschaft) describes very similar polymer materials, which are designated as “thermo-optic” therein. The transparency of the composition made of polymer materials and a monomer compound embedded therein is reversibly altered by the temperature-dependent refractive index difference. Alkanes, which are crystalline below a certain temperature and render the polymer material transparent, but which are amorphous/fused above this temperature so that the polymer material becomes turbid overall and less transparent to light, are proposed as embedded monomer compounds with highly temperature-dependent refractive indexes. The preferred polymer is a polyester. The polymer material is provided as a coating, for example on glass or facade elements.

Also known from DE 10 2007 061 513 A1 (Frauenhofer-Gesellschaft) is introducing the thermo-optically active substances as described above in so-called doping capsules and equipping polymers therewith in order to obtain, for example, sun shading films. With doping capsules, the optical properties of the capsule wall must also be taken into account.

A disadvantage of the systems functioning via the refractive index lies in the fact that the magnitude of the transparency reduction at a switching temperature is wavelength-dependent because each light refraction is itself wavelength-dependent and thus leads to an alteration of the spectrum of the incident light.

The general aim is to improve plant growth. An effort must therefore be made to provide the plants with the best possible growing conditions.

The problem addressed by the invention is therefore that of reducing or avoiding the disadvantages of the prior art and improving a self-shading or thermotropic film or plate such that it fulfills the requirements of plant production even better.

This problem is solved with a plant cultivation roofing made of film or plate material as claimed in claim 1, a method for growing useful plants as claimed in claim 14, and a master blend as claimed in claim 16.

Plant Cultivation Roofing

The plant cultivation roofing of the invention consists of a film or plate material with a temperature-dependent radiation transparency, of which the principle is known to the prior art and described above. The temperature-dependent radiation transparency is provided by at least one plastic layer in or on a plate or by at least one film layer within a single- or multilayer film. The temperature-dependent radiation transparency expresses itself in the form of a reduced optical transparency above a switching temperature. The radiation or light incidence on the crops being grown is thus regulated as a function of temperature. The switching temperature is understood to mean the temperature at which the optical transparency distinctly and rapidly decreases at higher temperatures (usually in a wavelength-dependent manner).

The difference in optical transparency below and above the switching temperature is also referred to as switching stroke. In the context of this invention, the switching stroke shall be defined as the transmission reduction or rather transparency reduction of the total radiation determined from the difference of the integral under the transmission curves in the 300 to 3000 nm wavelength range in terms of the higher transmission (starting curve) below the switching temperature. The switching stroke can then be expressed as a percent in terms of the original transmission of the film or roofing material below the switching temperature.

The distinguishing feature of the invention is that the at least one layer with the temperature-dependent radiation transparency shows a gradual or two- or multistep transparency reduction in response to rising temperatures in a temperature range starting from 20° C. This means that rather than a switching temperature, the layer or material of the invention having temperature-dependent radiation transparency has a switching (temperature) interval between a lower temperature limit and an upper temperature limit.

The invention possesses numerous advantages based on the switching interval. Of great significance is the optimization of the conditions for the plants and the better use of the PAR range as well as the regulation of the incident heat radiation. Let us examine a film of the invention with a switching interval between the lower temperature limit Tₐ and the upper temperature limit T_{b}. While a standard thermotropic film with a switching temperature at Tₐ would have provided the crop with optimum protection against excessive solar irradiation and overheating above Tₐ, in doing so it would have deprived it of much valuable PAR radiation needed for photosynthesis. While a standard film with a switching temperature T_{b} would have let in more of the PAR radiation essential to the plant, it would not have protected it against overheating as effectively. By virtue of several switching temperatures in a switching interval or preferably by virtue of a gradual transparency reduction in response to temperatures increasing from Tₐ to T_{b}, the plant will be supplied with as much light as possible but will still be protected. A relatively large portion of the incident PAR radiation is converted from direct PAR radiation to diffuse radiation, which has very beneficial effects on plant development.

In contrast to the film or plate material used in the invention, the whitewashing of greenhouse films acts on the radiation incidence side and reflects a portion of this radiation directly. This provides effective protection from intense heat, but the light for the plants is nearly completely lost in the process. In contrast, the modification of the plastic material of the thermotropic plastic layer within the film acts partly through absorption and partly through diffusion so that the diffuse light fraction, which is essential for plant production, is greatly increased compared to just whitewashing. The switching interval optimally combines a maximum of transmitted PAR radiation with a relatively high conversion into diffuse radiation.

According to the invention, the lower temperature limit of the switching interval should be at least 20° C., but can also be set higher, for instance to ca. 25° C. or 28° C. or 30° C. Further preference is given to the gradual transparency reduction of the plant cultivation roofing of the invention taking place between 20 and 50° C., preferably between 25 and 40° C. In this process the temperature interval or rather the switching interval can be smaller than 30° C. and lie within the range of 20 to 50° C. The individual switching temperatures are preferably between 20 to 50° C., more preferably between 25 to 40° C. for a two- or multistep transparency reduction as well.

In the case of a graduated switching performance, preference is given to the temperature interval between the lower switching limit (Tₐ) and the upper temperature switching limit (T_{b}) constituting a 3° C. to 30° C. temperature difference, preferably a 5° C. to 30° C. temperature difference, and more preferably a 10° C. to 30° C. temperature difference. The total switching stroke is executed within this temperature interval.

In the case of a two- or multistep transparency reduction, the material has several switching temperatures in the desired temperature range from 20° C. to higher temperatures. These are preferably at least two switching temperatures at 28° C.±3° C. and at 32° C.±3° C. Provision can also be made of more than two switching temperatures, which preferably lie between 25° C. and 45° C. and can include the two switching temperatures at 28° C. and at 32° C.

In the invention, the material that provides the temperature-dependent radiation transparency is in principle a plastic material or rather a polymer material. Optically transparent plastic materials suitable for film roofings or other plastic roofings are known in principle to the prior art. As a rule the latter are semi-crystalline materials with good optical transparency, for example polyolefins such as polyethylenes, polypropylenes, in particular LDPEs and also polyethylene copolymers such as ethylene butyl acrylate copolymer or ethylene vinyl acetate copolymer (EVA) or mixtures or rather blends of such polymers. Polyesters such as PET are furthermore suitable as base film materials. These film materials as such retain shortwave UV light to a high degree, which among other things is due to the CH single bonds and double bonds. IR radiation on the other hand is partially transmitted.

The plant cultivation roofing of the invention preferably allows the IR-A and the IR-B fraction to pass through to the extent that, in the reduced transparency state (ON mode) of the film or plate material, the transmitted radiation fraction is reduced by at least 5%, more preferably by at least 20% compared to the incident radiation fraction. This constitutes direct overheating protection. The transmitted IR-A and IR-B radiation is absorbed by the soil and gradually released as longwave radiation, which effects a good temperature balance. The plants are thus provided with a balanced soil temperature climate and protection against nighttime cold.

According to a particularly preferred embodiment, the plant cultivation roofing can be produced from a film material. Cover and greenhouse films are in principle well-known in the prior art and widely used. For greenhouses, the films are fixed in frames. However, use is also made of other forms of roofing, e.g., tent-like roofing, film tunnels, and the like. The requirements for films for greenhouse construction for Europe are described in DIN EN 13206 and in KTBL Worksheet No. 0687. A wide variety of materials with additives are available on the market. The main additive components used include mineral additives for adjusting the thermicity (IR-C barrier) and UV stabilizers. The purpose of UV stabilizers is to make the films more durable. The film material for the plant cultivation roofing of the invention is preferably a multilayer film, wherein at least one single film or layer contained therein effects a temperature-dependent transparency reduction. The multilayer film can be composed of, say, three layers, wherein thicknesses of 50 μm, 100 μm, and 50 μm, respectively, are typical. The three layers can be co-extruded. Advantageously, the film as a whole is produced by blowing extrusion. Preference is given to the middle layer of the three-layer film or to an inner layer of a multilayer film being the layer with the temperature-dependent transparency reduction. Particular preference is given to an LDPE, an ethylene butyl acrylate copolymer, or in particular an EVA as the matrix polymer. The total layer thickness of the multilayer film or of a corresponding single layer film is preferably 150 μm to 300 μm.

In the case in which the plant cultivation roofing is made of a plate material, preference is given to a plastic plate configured as single or multilayered and having at least one layer with temperature-dependent transparency reduction performance. As an alternative, a plastic plate or a glass plate can be embodiment, the plate can consist of a film or layer with temperature-dependent radiation transparency sandwiched between glass plates or plastic plates. The plate material is particularly advantageous in greenhouse construction. It can also be used for raised roofings in which, for example, a plate is set on posts at its four corners such that the plants are protected against direct solar irradiation from above but the surrounding air is able to circulate freely from the sides.

In principle, the graduated switching performance in the film or plate material or the alternative two- or multistep switching performance can be achieved in different ways.

As described above, on the one hand additives are known that can be added to a matrix polymer and effect a transparency reduction, generally by means of opacification, at a switching temperature. To implement the invention, a plurality of such additives can be added to a matrix polymer, which each realize a specific switching temperature individually and provide a multistep switching interval jointly. Frequently, however, it is also possible to mix the required substances, i.e., the individual additives, beforehand and thus create a new additive out of a substance mixture that effects a gradual or stepwise transparency reduction in response to rising temperatures. A mixed additive is achievable by using, for example, a homologous alkane series or other homologous or chemically similar substances in which the switching temperature is set by the molecular weight or by the polymerization degree.

As described above with regard to the prior art, also known are thermotropic additives consisting of polymer blends that show separation effects at a switching temperature and increase the opacity in this manner. These two-phase miscible and separable polymer blends can be replaced by, for example, three-phase blends, the three phases of which have different refractive indexes. In the case of copolymers, use is made of block copolymers in which the domains generated by the blocks have different refractive indexes. Persons skilled in the art can easily select familiar thermotropic or thermo-optic substances and use them in the form of mixtures in the sense of the invention. Particular preference is given to C10 to C30 n-alkanes and/or corresponding branched alkanes, which are mixed in such a way that they have a stepwise or gradual switching performance.

Moreover, it is also possible to use the polymer compounds mentioned in EP 1 218 467 B1 (BASF) in suitable combinations. In doing so, preference is given to mixtures of different polymers with ring structural units and different polymers without ring structural units, as described in detail in EP 1 218 467 B1 and to which specific reference is made for the selection of compounds.

According to an aspect of the invention, the transparency-regulating film layer or plastic layer is such a layer that contains one or several substances, a polymer blend, or a copolymer for effecting a transparency reduction by means of opacification above a threshold temperature. Polymer blends or copolymers can be used to create thermotropic or thermo-optic layers. As an alternative, the thermotropic or thermo-optic layers that are needed for the invention can also be obtained by additivation of a matrix polymer with a thermotropic material. Accordingly, the transparency-regulating film or film layer in other preferred exemplary embodiments contains an additive, which effects a transparency reduction above a switching temperature, specifically and more preferably an increasing opacification of the composition in response to higher temperature. This is frequently brought about by the fact that the additive consists of monomeric substances, which each occur in a crystalline or solid state with good optical transparency below a temperature characteristic for the individual substance, whereas above the temperature or within a melting range, a change to the amorphous or fused state takes place and effects an opacification. A gradual transparency reduction or rather a multistep transparency reduction is achieved by mixing several such monomers.

According to a special embodiment, the additive can be encapsulated as described in DE 10 2007 061 513 A1 (Frauenhofer), for example. Various encapsulated additives with different switching temperatures or switching ranges can be used mixed in order to achieve the desired switching interval. As described above, the additive can preferably be present in a transparent matrix polymer; non-encapsulated additives can be polymerized in the form of minute droplets in the matrix polymer.

Also suitable as additives are known phase change materials (PCMs), which can likewise alter their refractive index and thus their optical transparency at the phase transition point. Hence organic phase change materials with crystalline and optically transparent solid states (e.g., fats, oils, etc.) are also suitable in the scope of the invention.

U.S. Pat. No. 4,505,953 describes pellets made of PCMs. When used as thermotropic substances, the phase transition temperatures must be the same as the switching temperatures. Epoxy polymers, polyurethanes, acryl polymers, cellulose acetate, and polyamides, among others, are listed as casing materials for the pelleted or encapsulated PCMs. The following are listed as possible PCMs: polyethylenes, Glauber salt, sodium sulfate decahydrate, sodium thiosulfate pentahydrate, calcium chloride hexahydrate, magnesium nitrate hexahydrate, a eutectic mixture of magnesium nitrate hexahydrate and ammonium nitrate, potassium fluoride tetrahydrate, sodium acetate trihydrate, stearic acid, a eutectic mixture of naphthalene and benzoic acid and paraffinic hydrocarbons.

In alternative embodiments, polymer blends or copolymers such as those described in EP 1 218 467 B1 can also be mixed with a matrix polymer so as to give rise to a temperature-dependent transparent layer. As described above, the matrix polymer is preferably a semi-crystalline polymer, in particular a polyolefin, polyolefin blend, or polyolefin copolymer, preferably chosen from the group consisting of PE, PP, LDPE, EVA, and PET.

As already mentioned, the plant cultivation roofing of the invention is preferably part of a greenhouse or raised canopy, a sunshade system, or any other field cover. Plant cultivation roofings also include agricultural films used as field covers, even without wire or rigid frame structures.

Master Blend

The invention further comprises a master blend for the production of a temperature-dependent transparent film or plastic layer that is suitable for a plant cultivation roofing according to the invention. The films or plastic layers for the invention are preferably produced by extrusion or rather co-extrusion or by extrusion-coating a substrate such as a plate. The master blend is characterized in that it contains temperature-dependent transparency regulating polymers and/or additives that effect a stepwise or gradual transparency reduction in the extruded film or layer in response to rising temperatures in the temperature range of 20 to 50° C. For this purpose the transparency-regulating polymers and/or additives are mixed with a matrix polymer or base polymer. The master blend is further characterized in that it contains a semi-crystalline, transparent matrix polymer and optionally other additives. The other additives include in particular mineral additives for setting a thermicity, UV protection additives, optionally emollients and other additives typically used for agricultural films and known to persons skilled in the art. The master blend is manufactured by producing and then granulating or pulverizing the desired plastic material for the film or layer. This powder or granular product is the master blend that will be melted and extruded. For manufacturing films preference is given to blowing extrusion, whereas for plate coating preference is given to extrusion coating with a slotted nozzle.

Other processing methods are possible and known to persons skilled in the art.

Method for Cultivating Useful Plants

The problem addressed by the invention is also solved by a method for cultivating (growing) useful plants in a greenhouse, under a roofing, or under a film cover, in which the light incidence on the plants is regulated in a temperature-dependent manner with the aid of the plant cultivation roofing of the invention. The advantages of this method have already been described above in connection with the plant cultivation roofing.

In a development of the invention, the method is implemented in such a way that the roofing or covering is in addition temporarily whitewashed.

In the following, standard whitewashing (without the roofing of the invention) will be described first: in Southern European regions there are typically three whitewashings per year, in which lime is applied in different concentrations at least in the months of February to May, depending on the weather and the plant species being grown under the roofing as well as the growth phases of the plants. The growing season starting in winter (January) generally does not require any lime initially. As the season progresses, lime is applied between February and May until maximum shading is achieved in the spring/summer transition period. The growing season starting in midsummer (around August) is begun with a maximum amount of lime in order to protect the young plants. The lime is removed with the ending of summer and transition into fall.

The shading intensity should be gauged according to whether the plants are in the vegetative or generative growth stage, among other things. The vegetative phase includes the growth of the plant organs (roots, leaves, shoots) that provide nutrition to the plant. Insufficient light leads to rapid growth of the plant with comparatively few shoots and a poorly developed root system. Generative growth refers to the development of plant organs for sexual reproduction (formation of flowers, fruits, and seeds). Excess light results in poorly developed flowers and the formation of spots on the fruits, which eventually become soft and lead to a distinct decline in fruit quality. Among other things, the transition from vegetative to generative growth is dependent on daylight hours. The presence of additional light in the morning and evening hours as well as sufficient shading in the midday and afternoon hours generally favors growth.

The plant cultivation roofing of the invention makes it possible to provide shading from the midday sun, which is particularly advantageous for plant development, wherein the greatest possible portion of PAR radiation is retained and much diffuse light is generated by the gradual or stepwise transparency reduction. Depending on how the intensity (height) of the switching stroke is configured, radiation can additionally be kept from the crops by whitewashing should the need arise, depending on the season and growth stage. The plant cultivation roofing of the invention is just not limed for as long a period as is typical for normal transparent greenhouse film. The switching stroke can be configured such that whitewashing can be avoided.

In Southern European regions, lime is preferably applied to the plant cultivation roofing of the invention only between April and September, or also between March and October. This means that the film or plate material in the plant cultivation roofings of the invention optimally regulates the climate conditions in the winter/spring as well as in the spring/summer transition period and that an additional whitewashing may be indicated only during the midsummer period.

The plant cultivation roofing of the invention is used without whitewashing in milder climate zones such as northern Germany, for example.

By effecting optimum light and temperature balances, the invention results in more vigorous growth in young plants as well as a sturdy root system. Higher productivity and higher plant quality are thus achieved.

Work Results—Sample Film

The sample film is composed of the base polymer EVA with typical additives and a thermotropic additive. The latter is a mixture of n-alkanes of different weights, which is finely distributed in the EVA and which effects a graduated alteration of the transmission in a temperature range of 28 to 40° C. This film was tested according to the criteria established for commercial films for greenhouse construction in field experiments in Almeria, Spain. In addition, the following laboratory results were obtained:

at constant temperature and change of the radiation intensity, the transmission performance is stable.

In other words, it is controlled in a temperature dependent manner and independently of the radiation intensity in the ON mode as well as in the OFF mode.

the transmission changes in a graduated manner in a temperature range of 28 to 40° C.,

the performance of the film is reversibly repeatable.

The characterization of the optical properties yielded the following results:

TABLE 1

| | | | Commercial film | |
|---|---|---|---|---|
| | Thermotropic film | | (INDASOL PLUS ®) | |
| Transmission | OFF mode | ON mode (50° C.) | no lime | with lime |
| PAR | 77% | 60% | 85% | 30% |
| Diffuse light | 70% | 100% | 45% | 80% |
| fraction | | | | |
| IR-A + IR-B | 50% | 20% | 60% | 1% |

The thermicity (IR-C transparency) of the thermotropic film is clearly less (6%), even without mineral additivation, than that of a commercial film with addition of mineral components (10%). Furthermore, the higher proportion of diffuse light compared to the commercial film has a positive impact on plant growth.

Comparative Observations on Plant Growth

Two experimental greenhouses in Almeria, each 4 m² in area, were operated since early March 2013 in order to compare plant growth under a thermotropic film and a commercial film with lime. Three tomato plants with an initial height of ca. 30 cm and already formed flowers as well as four tomato plants with first fruits and ca. 1 in height were introduced in each greenhouse. Pollination was by bumblebees.

The thermotropic film did not have a negative impact on the orientation and activity of the beneficial insect pollinators. Similar behavior is to be expected of insects used for biological pest control, which is on the rise.

After introducing the plants, which are typically planted in natural soil with humus and sand mixed in, a more stable and more stress-free behavior of the younger plants was observed under the thermotropic film. This observation suggests more rapid development of the root system and consequently improved nutrient and water uptake.

The principles of the invention will be explained again in the following, with reference to figures. Shown are:

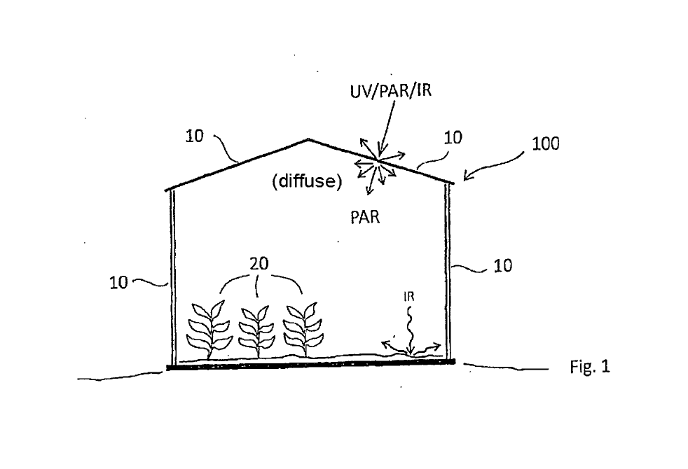

FIG. 1 schematic illustration of a greenhouse structure in cross-section,

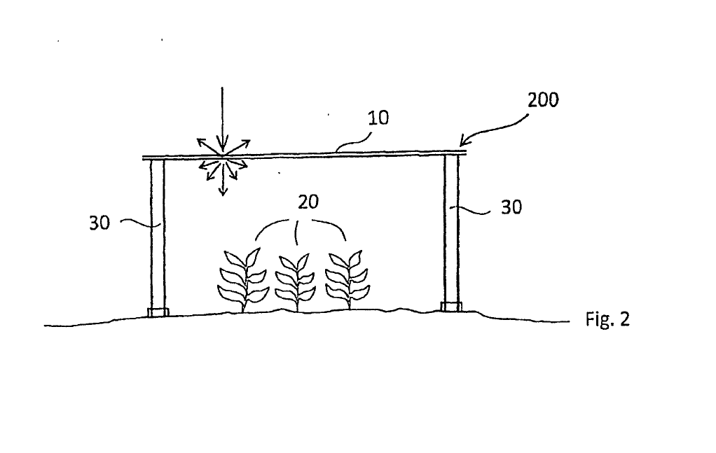

FIG. 2 schematic illustration of a raised roofing structure,

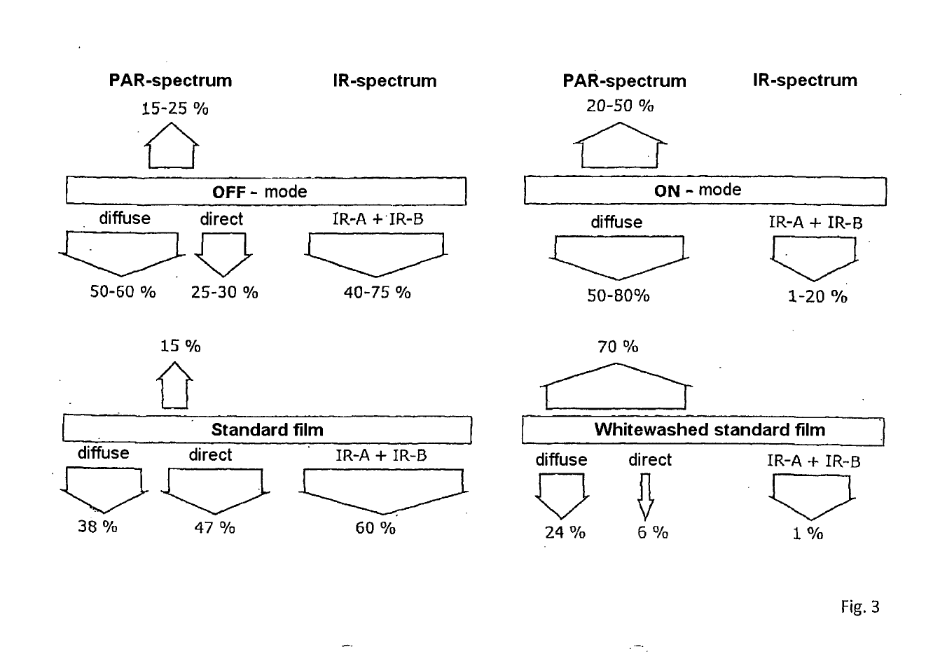

FIG. 3 comparison of the optical properties of a roofing material of the invention (top), a standard (reference) film, and a whitewashed standard film (bottom),

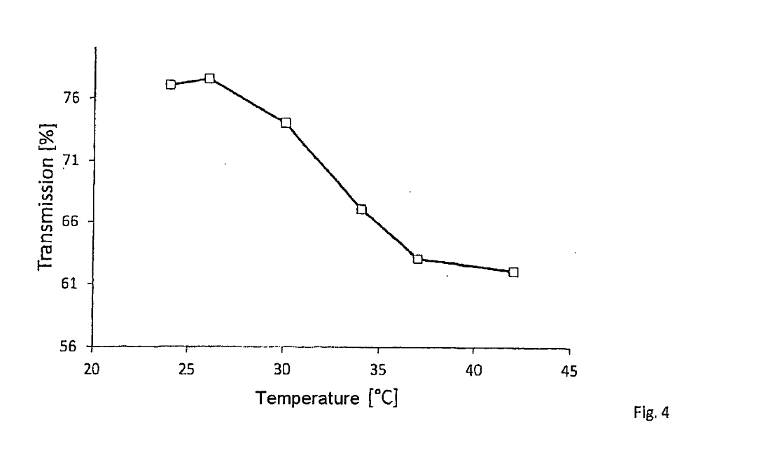

FIG. 4 PAR radiation transmission plotted against air temperature, 28 to 38° C. switching range.

FIG. 1 shows a greenhouse designated with 100, in which plant cultivation roofing 10 in the form of film material is used for the roof and walls of the greenhouse 100. Inside the greenhouse 100 there are plants 20, which are being grown in the greenhouse 100. As indicated by arrows, UV radiation as well as PAR radiation and IR radiation strike the roofing 10 as total radiation primarily from above, depending on the position of the sun. A portion of the incident radiation from the outside is always reflected, another portion is absorbed by the film, i.e., the material of the roofing 10, and still another portion is let through or rather transmitted. With the transmitted radiation, a distinction is made between direct radiation and radiation converted into diffuse light by refraction. The UV radiation is partially retained by the film material. The infrared radiation is partially transmitted. It is absorbed by the soil and slowly released back into the surroundings.

FIG. 2 illustrates a raised roofing structure 200, in which the plant cultivation roofing 10 is a plate or a film in a frame. The roofing 10 is supported by the posts 30. In this structure, air and pollinating insects have free access to the crop of plants 20. The structure shown in FIG. 2 is suited for southern regions, for example, in which the sun is very high in the sky. However, it can also protect certain crops from rain as well as from excessive solar radiation (for example during the midday heat period) in more northern regions.

The optical properties of the new film are illustrated in FIG. 3. In the non-shaded state (OFF mode), more than 70% of the PAR spectrum essential to the plants is transmitted and in addition already converted to a large extent into the desired diffuse light. Hence in comparison to the standard film illustrated below, not only is a greater fraction of the PAR spectrum essential for photosynthesis transmitted, but in addition the greater conversion into diffuse light is also advantageous. In comparison to the standard film, less near infrared (IR-A+IR-B) is transmitted, but nevertheless still enough to ensure balanced temperatures under the plant cultivation roofing during cold nighttime periods. After completely surpassing the switching interval, more PAR radiation is reflected and the penetrating radiation is almost completely converted into diffuse light in the ON mode illustrated in the top right. The plants are thus very effectively protected from being burned by direct radiation, but without adverse impacts on photosynthesis due to insufficient light.

In the ON mode of the novel film, considerably less near infrared is transmitted than in the OFF mode, which owing to the higher temperature level during the ON mode is also desirable. By comparison the whitewashed standard film illustrated in the bottom right of FIG. 3 only allows 30% of the PAR spectrum to reach the crop because 70% of the incident light is reflected. In this example, lime was applied at the rate of 75 g/m². In spite of the high degree of reflection, the proportion of diffuse light is less than with the thermotropic film of the invention. 6%, i.e., ca. 20% of the transmitted light, is still in the form of direct radiation. Whitewashing acts on the light incidence side. This explains the high degree of reflection and the low level of near infrared transmission. This shows that lime can be applied to the film of the invention as an additional measure during particularly hot periods and thus makes it possible to exclude radiation altogether, including thermal radiation.

FIG. 4 shows an experiment with a film of the invention on a chamber. The PAR radiation transmission is plotted against the air temperature. The lower switching temperature of the switching interval Tₐ to T_{b} is between 26 and 28° C. The switching interval ends at T_{b≃}42° C. As can be discerned, the switching stroke is distributed over the switching interval and transmission becomes less and less as the temperature rises. In this manner optimum use can be made of the PAR radiation essential to the plant. Transmission only decreases by ca. 15%. Nevertheless effective protection is ensured at high temperatures.

1. A plant cultivation roofing, comprising: film material or plate material having temperature-dependent radiation transparency provided by at least one plastic layer in or on a plate or by at least one film layer and which expresses itself as reduced optical transparency above a switching temperature, wherein the film material or plate material having the temperature-dependent radiation transparency has a gradual or a two- or multistep transparency reduction in response to rising temperatures in a temperature range starting from 20° C.

2. The plant cultivation roofing as claimed in claim 1, wherein the temperature-dependent radiation transparency is the gradual transparency and the transparency reduction occurs between 20 and 50° C.

3. The plant cultivation roofing as claimed in claim 1 wherein the temperature-dependent radiation transparency is a graduated switching performance with a switching stroke within a temperature interval of 3 to 30° C. temperature difference.

4. The plant cultivation roofing as claimed in claim 1, wherein the temperature-dependent radiation transparency has at least two switching temperatures which are at approximately 28° C.±3° C. and at approximately 32° C.±3° C.

5. The plant cultivation roofing as claimed in claim 1, wherein the temperature reduction in the spectral range between 400 nm and 720 nm is at most 50%.

6. The plant cultivation roofing as claimed in claim 1, wherein an IR-A and an IR-B fraction of the transmitted radiation is reduced by at least 5%, compared to the incident radiation in the transparency-reduced state (ON mode).

7. The plant cultivation roofing as claimed in claim 1, wherein the film material or plate material is a multilayer film and that at least one single film or layer contained therein effects a temperature-dependent transparency reduction.

8. The plant cultivation roofing as claimed in claim 1 wherein the film material or the plate material is a plastic plate, which is single- or multilayered and has at least one layer having temperature-dependent transparency reduction performance,
wherein the plastic plate is a glass or plastic plate coated with a layer having temperature-dependent radiation transparency, or
wherein the plastic plate is formed from a film or layer having temperature-dependent radiation transparency sandwiched between glass plates.

9. The plant cultivation roofing as claimed in claim 1 wherein the film material or plate material includes a layer that contains one or more substances selected from the group consisting of a polymer blend and a copolymer, for effecting a transparency reduction by means of opacification above a threshold temperature.

10. The plant cultivation roofing as claimed in claim 1 wherein the film material or plate material contains an additive composed of one or more substances which effects the gradual or a two- or multistep transparency reduction above a threshold temperature.

11. The plant cultivation roofing as claimed in claim 10, wherein the additive is encapsulated.

12. The plant cultivation roofing as claimed in claim 10 wherein the additive is present in either a transparent matrix polymer or a polymer blend or a copolymer mixed with a matrix polymer.

13. The plant cultivation roofing as claimed in claim 1 wherein the plant cultivation roofing is configured for association with part of a greenhouse, a raised roofing structure, a sunshade system, or a field cover.

14. A method for growing plants in a greenhouse, under a roofing or under a film cover, wherein light incidence on the plants is regulated in a temperature-dependent manner using the plant cultivation roofing as claimed in claim 1.

15. The method as claimed in claim 14, further comprising temporarily whitewashing the plant cultivation roofing.

16. A master blend for the manufacturing, by means of extrusion, of a temperature-dependent transparent film or plastic layer, which is suitable for a plant cultivation roofing as claimed in claim 1, comprising a content of temperature-dependent transparency-regulating polymers and/or additives that effect a stepwise or gradual transparency reduction in an extruded film or layer in response to rising temperatures in a 20 to 50° C. range.

17. The master blend as claimed in claim 16, wherein the content includes a semi-crystalline, transparent matrix polymer and optionally other additives.

18. The plant cultivation roofing of claim 3 wherein the temperature interval is a 5 to 30° C. temperature difference.

19. The plant cultivation roofing of claim 3 wherein the temperature interval is a 10 to 30° C. temperature difference.

20. The plant cultivation roofing as claimed in claim 1, wherein the temperature reduction in the spectral range between 400 nm and 720 nm is at most 20%.
